(19) United States
(12) Patent Application Publication
(10) Pub. No.: US 2013/0287451 A1
(43) Pub. Date: Oct. 31, 2013

(54) IMAGE FORMING APPARATUS, DEVELOPING APPARATUS, AND PROCESS CARTRIDGE

(71) Applicant: CANON KABUSHIKI KAISHA, Tokyo (JP)

(72) Inventors: Shinya Yamamoto, Numazu-shi (JP); Kodai Hayashi, Suntou-gun (JP); Hisashi Taniguchi, Suntou-gun (JP); Naoki Fukushima, Suntou-gun (JP); Yuichiro Hirata, Suntou-gun (JP); Nobuyoshi Yoshida, Suntou-gun (JP)

(21) Appl. No.: 13/868,594

(22) Filed: Apr. 23, 2013

(30) Foreign Application Priority Data
Apr. 26, 2012 (JP) 2012-100958
Apr. 26, 2012 (JP) 2012-101862

(51) Int. Cl. G03G 15/08

(52) U.S. Cl. CPC G03G 15/0806
USPC 399/281; 399/285

(57) ABSTRACT

A developing roller configured to develop an electrostatic latent image on a photosensitive drum, a supply roller configured to supply developer to the developing roller are provided, and the surface of the developing roller moves in the same direction as the surface of the photosensitive drum and at a speed higher than the photosensitive drum at a nip portion between the photosensitive drum and the developing roller, the surface of the supply roller moves in the same direction as the surface of the developing roller and at a speed higher than the developing roller at a nip portion between the developing roller and the supply roller.

### BACKGROUND OF THE INVENTION

1. Field of the Invention

The present disclosure relates to an electrophotographic image forming apparatus. Here, the term “electrophotographic image forming apparatus” means an apparatus configured to form an image on a recording medium (for example, recording sheet, OHP sheet, and cloth) using an electrophotographic image forming method. Examples of the electrophotographic image forming apparatus include, for example, an electrophotographic copying machine, an electrophotographic printer (for example, a laser beam printer, and an LED printer), a facsimile apparatus, and a multiple function processing machine (multifunction printer).

The term “process cartridge” is a member including an electrophotographic photosensitive member and at least one of a charging unit, a developing unit, and a cleaning device as a process unit configured to act on the electrophotographic photosensitive member integrated into a cartridge. Then, the cartridge is configured to be demountably mountable with respect to an electrophotographic image forming apparatus body.

2. Description of the Related Art

In recent years, a color image forming apparatus configured to form a color image using a plurality of colors of developer becomes widely used. As the color image forming apparatus, a so-called inline-system image forming apparatus in which photosensitive members corresponding respectively to image forming actions using a plurality of colors of developer are arranged in a row along the direction of movement of the surface of a transfer member to which a toner image is transferred is known. The inline system is a preferably image forming system in terms of being adaptable to requirements such as a high image forming speed and development to a multifunction printer.

One of the inline-system image forming apparatus includes a plurality of photosensitive members arranged below a recording material carrying member configured to convey an intermediate transfer member as the transfer member, or a recording material as a transfer member. When arranging the photosensitive members below the intermediate transfer member or the recording material carrying member, for example, a fixing apparatus and a developing apparatus (or an exposing apparatus) may be arranged at positions apart from each other in a state in which the intermediate transfer member and the recording material carrying member sandwiched therebetween in an image forming apparatus body. Therefore, there is an advantage that the developing apparatus (or the exposing apparatus) is hardly affected by heat of the fixing apparatus.

In many of the color image forming apparatuses, a contact developing system is widely used in terms of advantages such as reproducibility of half-tone images and restraint of excessive edge effect of an image. The term “contact developing system” means a system of bringing a developer carrying member of the developing apparatus into contact with the electrophotographic photosensitive members and developing latent images formed on the electrophotographic photosensitive members by using developer (toner).

As a configuration of the contact developing system, one of the electrophotographic photosensitive members and the developer carrying member is generally formed of a resilient member (including a sheet backed up by the resilient member) and the other one of those is formed of a rigid member in order to achieve uniform and tight contact with each other in the direction of axes of rotation thereof. Examples of simple configurations of the electrophotographic photosensitive member include a photosensitive drum. The photosensitive drum is manufactured by applying a photosensitive layer on an outer peripheral surface of an aluminum cylinder. The simple configuration of the developer carrying member is a developing roller formed of a rubber resilient member. In particular, when the configuration includes the electrophotographic photosensitive member and the developer carrying member as a process cartridge which is demountably mountable on the image forming apparatus body, the above-described combination is employed in many cases.

A resilient roller as a supply member configured to supply toner is in contact with the developing roller, and the toner supply to the developing roller and peeling off of the undeveloped toner therefrom are performed.

In contrast, when the photosensitive member is arranged below the intermediate transfer member or the recording material carrying member as described above, there may be a case where the developer needs to be supplied to the developer carrying member or the supply member against the gravitational force in the developing apparatus. In other words, a developing apparatus configured to convey the developer from a developer storage section arranged below the supply member to the supply member needs to be employed. As regards the developing apparatus having such a configuration, a configuration of supplying a sufficient amount of toner from the developer storage section to a supply roller against the gravitational force is described in Japanese Patent Laid-Open No. 2003-173083. In Japanese Patent Laid-Open No. 2003-173083, a method of bringing a receiving sheet into contact with a lower side of the supply member as a device for supplying developer to the supply member is disclosed. According to the method described above, the receiving sheet prevents lowering of the solid image density by preventing the developer deposited on the supply member from dropping off due to the gravitational force so as to avoid the reduction of the developer that can be supplied to the developer carrying member.

However, according to the configuration of the related art described above, there is a case where the quantity of the toner on the receiving sheet may be reduced instantaneously in a case where an image with a high printing ratio is formed. In such a case, friction between the supply member and the developer carrying member becomes unstable, and a stick-slip phenomenon may occur at a nip portion between the developing roller and the photosensitive drum, so that banding may occur on the image.

The disclosure provides an image forming apparatus configured to reduce banding of the image by using a developing apparatus configured to convey developer from a developer storage section arranged below a supply member onto the supply member.

In a configuration in which powder is held on a developer carrying member of a pair of the developer carrying member and the supply member, the disclosure also provides a developing apparatus configured to achieve further reduction of an initial drive torque.

### SUMMARY OF THE INVENTION

The present disclosure provides an image forming apparatus including: an image carrying member on which an electrostatic latent image is carried; a developing apparatus including: a developer carrying member configured to form a first nip portion with respect to the image carrying member and develop the electrostatic latent image at the first nip portion; a supply member configured to form a second nip portion with respect to the developer carrying member and supply a developer to the developer carrying member at the second nip portion; a storage section arranged below the supply member and configured to store the developer; and a conveying member configured to convey the developer in the storage section on the supply member, wherein the surface of the developer carrying member moves in the same direction as the surface of the image carrying member and at a speed higher than the surface of the image carrier member at the first nip portion, and the surface of the supply member moves in the same direction as the surface of the developer carrying member and at a speed higher than the surface of the developer carrying member at the second nip portion.

There is also provided a developing apparatus including: a developer carrying member configured to carry developer and develop an electrostatic latent image; a supply member configured to form a nip portion with respect to the developer carrying member and supply a developer to the developer carrying member at the nip portion; a storage chamber configured to store the developer; and a removable seal member configured to prevent the developer from flowing from the storage section to the developer carrying member, wherein powder is retained on the surface of the developer carrying member in a state in which the developing apparatus is not in use, and the developer carrying member and the supply member rotate so as to move in the same direction at the nip portion and the supply member rotates 360° or more until the developer carrying member rotates 360° at the time of initial driving of the developing apparatus.

According to the disclosure, there is provided an image forming apparatus configured to reduce banding of the image by using a developing apparatus configured to convey a developer from a developer storage section arranged below a supply member onto the supply member.

According to the disclosure, in the developing apparatus in which powder is retained on a developer carrying member from a pair of the developer carrying member and the supply member, further reduction of an initial drive torque is achieved.

Further features of the present invention will become apparent from the following description of exemplary embodiments with reference to the attached drawings.

### BRIEF DESCRIPTION OF THE DRAWINGS

FIG. 1 is a schematic drawing illustrating a configuration of a cross section of an electrophotographic image forming apparatus of Example 1.

FIG. 2 is a schematic drawing illustrating a configuration of a cross section of a process cartridge of Example 1.

FIG. 3 is a cross-sectional view illustrating a configuration of an image forming apparatus provided with a developing apparatus of Example 1.

FIG. 4 is a cross-sectional view illustrating a configuration of the developing apparatus.

FIG. 5 is a perspective view of a charging amount measuring apparatus configured to measure the charging amount of powder.

FIG. 6 is a cross-sectional view illustrating a configuration of the image forming apparatus provided with a developing apparatus of Example 3.

FIGS. 7A and 7B are cross-sectional views illustrating a configuration of a cartridge.

### DESCRIPTION OF THE EMBODIMENTS

Referring now to the drawings, the invention will be described. Sizes, materials, and shapes of the components, and relative arrangement thereof described in Embodiments are not intended to limit the scope of the invention only to those values unless otherwise specifically described.

### EXAMPLES

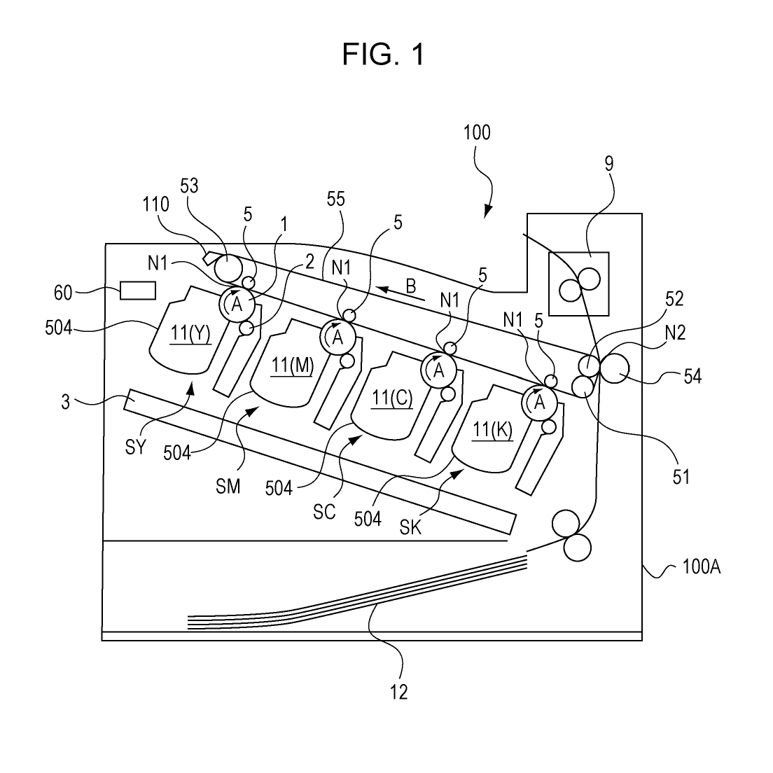

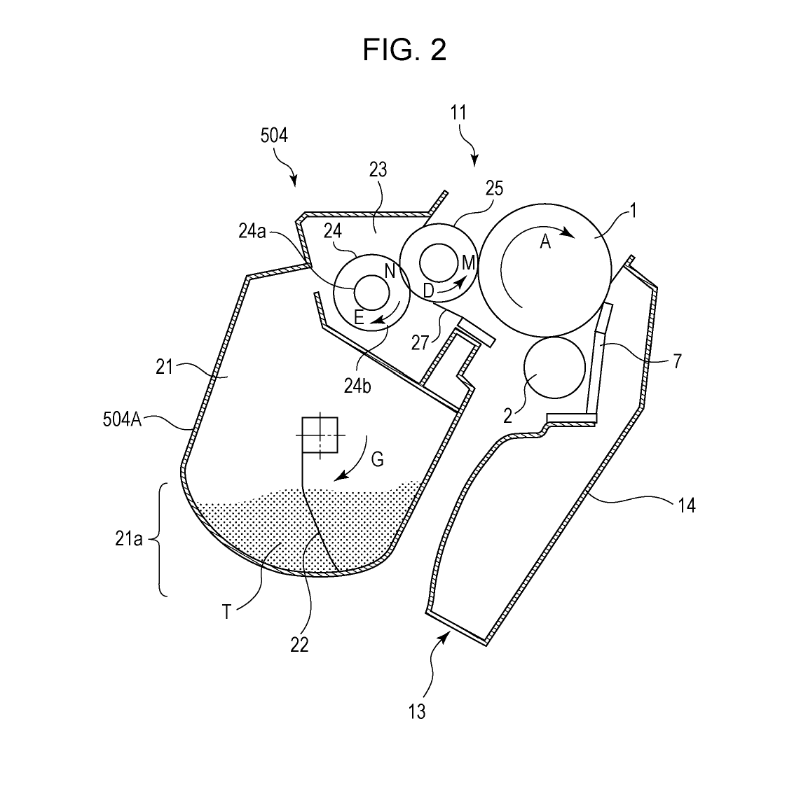

Referring now to FIG. 1 to FIG. 2, Example 1 of the disclosure will be described.

### Image Forming Apparatus

First of all, a general configuration of an electrophotographic image forming apparatus (image forming apparatus) according to the disclosure will be described.

FIG. 1 is a schematic cross-sectional view of an image forming apparatus 100 of Example 1. The image forming apparatus 100 of Example 1 is a full-color laser printer in which an inline system and an intermediate transfer system are employed. The image forming apparatus 100 is capable of forming a full-color image on recording materials (for example, recording paper, plastic sheet, and cloth) according to image information. The image information is input to an image forming apparatus body 100A from an image scanning apparatus connected to the image forming apparatus body 100A or from a host apparatus such as a personal computer connected to the image forming apparatus body 100A so as to be capable of communicating with each other.

The image forming apparatus 100 includes first, second, third, and fourth image forming units SY, SM, SC, and SK configured to form images of respective colors; yellow (Y), magenta (M), cyan (C), and black (K) as a plurality of image forming units. In Example 1, the first to fourth image forming units SY, SM, SC, and SK are schematically arranged in a row in the direction intersecting the perpendicular direction.

In Example 1, the configuration and the operation of the first to fourth image forming units SY, SM, SC, and SK are the same except that the colors of the images to be formed are different. Therefore, in the following description, suffix alphabets Y, M, C, and K are omitted in order to indicate that the description is applied to any one of those components provided for four colors unless otherwise discrimination is needed and general description is given.

In other words, in Example 1, the image forming apparatus 100 includes four drum-shaped electrophotographic photosensitive members arranged in parallel in the direction intersecting the perpendicular direction, that is, photosensitive drums 1 as a plurality of image carrying members. In the periphery of each of the photosensitive drums 1, a charging roller 2 as a charging unit configured to charge the surface of the photosensitive drum 1 uniformly, and a scanner unit (exposing apparatus) 3 as an exposing device configured to form an electrostatic image (electrostatic latent image) on the photosensitive drum 1 by irradiating laser on the basis of the image information are arranged. In addition, a developing unit (developing apparatus) 4 as a developing apparatus configured to develop the electrostatic image as a toner image, and a cleaning blade 7 as a cleaning device configured to remove the toner remaining on the surface of the photosensitive drum 1 after the transfer (residual toner) are arranged. An intermediate transfer belt 55 as an intermediate transfer member configured to transfer the toner images on the four photosensitive drums 1 to a recording material 12 are arranged so as to oppose the four photosensitive drums 1.

In Example 1, the developing unit 4 uses toner, which is non-magnetic one-component developer as the developer. In Example 1, the developing unit 4 is configured to perform a reversal developing developing by bringing a developing roller (described later) as a developer carrying member into contact with the photosensitive drum 1. In other words, in Example 1, the developing unit 4 develops the electrostatic image by causing the toner charged into the same polarity as the polarity at which the photosensitive drum 1 is charged (negative pole in Example 1) to adhere portions where the charge is attenuated by the exposure on the photosensitive drum 1 (an image portion, an exposed portion).

In Example 1, the photosensitive drum 1, the charging roller 2 as a process unit acting on the photosensitive drum 1, the developing unit 4, and the cleaning blade 7 are integrated and, in other words, integrated into a cartridge, so as to form a process cartridge 11. The process cartridge 11 is configured to be demountably mounted on the image forming apparatus 100 via a mounting device such as a mounting guide or a positioning member provided on the image forming apparatus body 100A. In Example 1, the respective process cartridges 11 for the respective colors have the same shape, and the respective process cartridges 11 store yellow (Y) toner, magenta (M) toner, cyan (C) toner, and black (K) toner, respectively.

The intermediate transfer belt 55 formed of an endless belt as an intermediate transfer member comes into contact with all the photosensitive drums 1, and circulates (rotates) in the direction indicated by an arrow B in the drawing (counterclockwise). The intermediate transfer belt is stretched around a drive roller 51, a secondary transfer opposed roller 52, and a driven roller 53 as a plurality of supporting members.

On the side of an inner peripheral surface of the intermediate transfer belt 55, four primary transfer rollers 5 as primary transfer devices are arranged in parallel so as to oppose the respective photosensitive drums 1. The primary transfer rollers 5 press the intermediate transfer belt 55 toward the photosensitive drums 1, and form primary transfer portions N1 where the intermediate transfer belt 55 and the photosensitive drums 1 come into contact with each other. Then, a bias voltage having a polarity opposite from the polarity at which the toner is normally charged is applied from a primary transfer bias power source (high-voltage power source) as a primary transfer bias application device, not illustrated on the primary transfer rollers 5. Accordingly, the toner images on the photosensitive drums 1 are transferred onto the intermediate transfer belt 55 (primary transfer).

On the side of an outer peripheral surface of the intermediate transfer belt 55 at a position opposing the secondary transfer opposed roller 52, a secondary transfer roller 54 as a secondary transfer device is arranged. The primary transfer rollers 54 is in press-contact with the secondary transfer opposed roller 52 via the intermediate transfer belt 55, and form a secondary transfer portion N2 where the intermediate transfer belt 55 and the secondary transfer roller 54 come into contact with each other. Then, a bias voltage having a polarity opposite from the polarity at which the toner is normally charged is applied from a secondary transfer bias power source (high-voltage power source) as a secondary transfer bias application device, not illustrated, on the secondary transfer rollers 54. Accordingly, the toner image on the intermediate transfer belt 55 is transferred to the recording material 12 (secondary transfer).

Further specifically, the surfaces of the photosensitive drums 1 are firstly charged uniformly by the charging rollers 2 at the time of image formation. Then, the surfaces of the charged photosensitive drums 1 are scanned and exposed by laser beams in accordance with the image information emitted from the scanner unit 3, and electrostatic images in accordance with the image information are formed on the photosensitive drums 1. Subsequently, the electrostatic images formed on the photosensitive drums 1 are developed as toner images by the developing unit 4. The toner images formed on the photosensitive drums 1 are transferred onto the intermediate transfer belt 55 by an action of the primary transfer rollers 5 (primary transfer).

For example, at the time of full-color image formation, the above-described process is performed in sequence on the first to fourth image forming units SY, SM, SC, and SK and the toner images of the respective colors are primarily transferred onto the intermediate transfer belt 55 one on top of another.

Then, the recording material 12, being synchronized with the movement of the intermediate transfer belt 55, is conveyed to the secondary transfer portion N2. The toner images on four colors on the intermediate transfer belt 55 are secondarily transferred at once onto the recording material 12 by the action of the secondary transfer roller 54 being in contact with the intermediate transfer belt 55 via the recording material 12.

The recording material 12 on which the toner images are transferred is conveyed to a fixing apparatus 9 as a fixing device. By the application of heat and pressure on the recording material 12 in the fixing apparatus 9, the toner images are fixed to the recording material 12.

A primary residual toner remaining on each one of the photosensitive drums 1 after a primary transfer process is removed and collected by the cleaning blade 7. A secondary residual toner remaining on the intermediate transfer belt 55 after a secondary transfer process is cleaned by an intermediate transfer belt cleaning apparatus 110.

The image forming apparatus 100 is configured to be capable of forming a monochrome or a multicolored image by using only a desired single image forming unit or some of (not all) the image forming units.

### Process Cartridge

Subsequently, the process cartridge 11 to be mounted on the image forming apparatus 100 in Example 1 will be described.

FIG. 2 is a schematic cross-sectional (main cross-sectional) view illustrating the process cartridge 11 of Example 1. The posture of the process cartridge 11 in FIG. 2 is a posture in a state of being mounted on the image forming apparatus body and, when the positional relationships among the respective members of the process cartridge or the directions thereof are described below, the positional relationships and the directions with respect to the posture illustrated in FIG. 2 are shown. In Example 1, configurations and the operation of the process cartridge 11 for the respective colors are experimentally the same except for the type (color) of the developer contained therein.

The process cartridge 11 includes a photosensitive unit 13 including the photosensitive drum 1, and the developing unit 4 including a developing roller 25 integrated with each other.

The photosensitive unit 13 includes a cleaning frame body 14 as a frame body configured to support the respective components in the photosensitive unit 13. The photosensitive drum 1 is rotatably mounted on the cleaning frame body 14 via a bearing, not illustrated.

The photosensitive drum 1 has a diameter of φ30 mm, is driven to rotate in the direction indicated by an arrow A in the drawing (clockwise) in accordance with an image forming action by a drive force of a drive motor as a drive unit (drive source), not illustrated, in the direction indicated by the arrow A in the drawing (clockwise) transmitted to the photosensitive unit 13, and has the process speed of 64 mm/sec. In Example 1, the photosensitive drum 1 as a center of an image forming process is an organic photosensitive drum 1 coated with an undercoat layer, a carrier generating layer, and a carrier transferring layer as functional layers in sequence on an outer peripheral surface of an aluminum cylinder. The carrier transfer layer forming the surface of the photosensitive drum 1 has a substantially mirror surface and has a surface roughness (Rzjis) of 1 μm. As a result of measurement of the surface hardness using a Vickers pyramid diamond indenter, the universal hardness value (HU) when the diamond indenter is pressed inward at a load of 6 mN was within 150 to 220 N/mm².

The photosensitive unit 13 includes the cleaning blade 7 as a cleaning member and the charging roller 2 arranged so as to come into contact with a peripheral surface of the photosensitive drum 1. The cleaning blade 7 is in contact with the photosensitive drum 1 in the direction opposite from the direction of rotation of the photosensitive drum 1, and hence the residual toner removed from the surface of the photosensitive drum 1 is dropped and stored in the cleaning frame body 14.

As described above, the photosensitive drum 1 is driven to rotate in one direction in the direction indicated by the arrow A in the drawing according to the image forming operation. As described above, the cleaning blade 7 is in contact with the photosensitive drum 1 in the direction opposite from the direction of rotation of the photosensitive drum 1, that is, the cleaning blade 7 is in contact with the photosensitive drum 1 in the direction to positively resist the rotation of the photosensitive drum 1.

Accordingly, the cleaning blade 7 performs a braking control by applying brakes on photosensitive drum 1 and preventing the rotating speed thereof from increasing by the influence of the developing roller 25 coming into contact with and intruding into the photosensitive drum 1 and rotating at a peripheral speed higher than the photosensitive drum 1. Therefore, the rotations of the photosensitive drum 1 and the developing roller 25 are prevented from shaking and occurrence of banding on the image is prevented.

The cleaning blade 7 has a configuration in which urethane rubber is bonded on a metal plate having a thickness t of 1.2 mm, and the amount of intrusion δ into the drum is 1.0 mm.

The charging roller 2 as the charging unit is driven to rotate by pressure-contact of a roller portion of a conductive rubber with the photosensitive drum 1. Therefore, the rotation of the photosensitive drum 1 is not specifically affected.

A core metal of the charging roller 2 is applied with a predetermined DC voltage with respect to the photosensitive drum 1 in the charging process, whereby a uniform dark-area potential (Vd=−500V) is formed on the surface of the photosensitive drum 1. A laser beam spot pattern of laser beams emitted from the above-described scanner unit 3 corresponding to the image data exposes the photosensitive drum 1, and the charge on the surface of the exposed portions is eliminated by a carrier from the carrier generating layer, so that the potential is lowered. Consequently, on the photosensitive drum 1, the exposed portion is formed with an electrostatic latent image having a predetermined light-area potential (V1=−100V), and the non-exposed portion is formed with an electrostatic latent image having a predetermined dark-area potential (Vd=−500V). In order to develop and visualize the electrostatic latent image formed on the photosensitive drum 1 by toner, a voltage of Vdc=−300V is applied on the developing roller 25 which comes into abutment contact and rotates with the photosensitive drum 1 as a developing bias.

Subsequently, the developing unit 4 will be described.

The developing unit 4 is arranged downward of a supply roller 24 in the direction of gravitational force, and is provided with a developer storage chamber for storing toner T, that is, a toner storage chamber 21.

A stirring conveying member 22 is provided in the toner storage chamber 21. The stirring conveying member 22 is configured to stir the toner stored in the toner storage section 21a in the toner storage chamber 21, and convey the toner to an upper portion of the supply roller 24 in the direction indicated by an arrow G in the drawing. In Example 1, the stirring conveying member 22 rotates at 50 rpm.

The toner T of Example 1 is a substantially spherical shaped non-magnetic toner having negative chargeability as one-component developer. The center particle diameter is approximately 7 μm, and hydrophobic silica is externally added as fluidity imparting additive 1.5 wt %. By coating the toner surface with external additive, improvement of negative charging performance and fluidity is achieved by providing minute clearances between the toner particles.

The developing unit 4 includes a developing frame member 504A as a frame member configured to support respective components in the developing unit 4.

The developing roller 25 has a configuration provided with a conductive resilient member on an outer peripheral surface of an SUS core metal so as to have a diameter of 15 mm. In Example 1, polyurethane rubber is employed as the resilient member. Volume resistivity when a voltage of −50V is applied is set to be on the order of 10⁵ to 10⁶Ω in terms of developing performance and the image quality. The developing roller 25 has an Asker C hardness of 45° and a JISA hardness of 25°. The surface roughness Rzjis of the developing roller 25 is 7.0 μm.

A developing blade 27 is in contact with the developing roller 25 in the direction opposite from the direction of rotation of the developing roller 25, and control of the coating amount and provision of charging with respect to the toner supplied by the supply roller 24 are performed. The developing blade 27 is an SUS metal plate formed of a thin plate-shaped member and is configured to generate a contact pressure by using spring resiliency of a thin plate, and the surface thereof comes into abutment contact with the toner and the developing roller 25. In Example 1, the developing blade 27 is in contact with the developing roller 25 in the direction opposite from the direction of rotation of the developing roller 25. In other words, the developing blade 27 is in contact with the developing roller 25 in the direction to resist the rotation of the developing roller 25.

The toner is charged by triboelectric charging caused by sliding friction with the developing blade 27 and the developing roller 25 and, simultaneously, is controlled in layer thickness. In Example 1, a predetermined voltage is applied from a blade bias power source, not illustrated, to the developing blade 27 to achieve the stabilization of the toner coat. In Example 1, a voltage Vdc of −300V is applied to the developing roller 25 as the developing bias for developing and visualizing the electrostatic latent image formed on the photosensitive drum 1 by the toner. A voltage Vb1 of −400V is applied to the developing blade 27.

The supply roller 24 has a diameter of φ15 mm, and is provided with a conductive supporting member and a foam layer supported by the conductive supporting member. Specifically, a core metal electrode 24a of the conductive supporting member and a urethane foam layer 24b formed of continuous air bubbles (open cell) having continued air bubbles therearound as a foam layer. By forming the urethane of the surface layer with the continuous air bubbles, a large amount of toner is allowed to enter the interior of the supply roller 24. The surface cell diameter of the supply roller 24 is set to be 100 μm to 400 μm. The supply roller 24 has an Asker C hardness of 10° or lower and an Asker F hardness of 60°. The surface roughness Rzjis of the supply roller 24 is 50 μm as a result of non-contact roughness measurement.

A resistance of the supply roller 24 in Example 1 is 1×10⁸ (Ω). Here, a method of measurement of the resistance of the supply roller 24 will be described. The supply roller 24 is brought into contact with an aluminum sleeve of φ30 mm so that the amount of intrusion, described later, becomes 1.0 mm. By rotating the aluminum sleeve, the supply roller 24 is driven to rotate with respect to the aluminum sleeve at 30 rpm. Subsequently, a DC voltage of −50V is applied to the supply roller 24. At this time, a resistance of 10 kΩ is provided on the earth side, and the current is calculated by measuring the voltages at both ends thereof and then the resistance of the supply roller 24 is calculated.

The supply roller 24 forms a nip portion N (first nip portion) formed so as to sandwich the toner at a portion opposing the developing roller 25. At the nip portion N, toner supply to the developing roller 25 by the supply roller 24 and removal of the toner remaining on the developing roller 25 remaining as a residual toner after development are performed. In Example 1, the supply roller 24 rotates at 100 rpm, and the developing roller rotates at 200 rpm in the direction indicated by an arrow E in the drawing so that the surfaces of the respective rollers move in the same direction (the direction from up to down in Example 1). The peripheral speeds thereof are 160 mm/sec. and 80 mm/sec., respectively. In other words, the peripheral speed ratio expressed by peripheral speed of the supply roller/the peripheral speed of the developing roller is 200%.

The amount of intrusion between the developing roller 25 and the supply roller 24 at the nip portion N is 1.0 mm.

In Example 1, the hardness of the supply roller 24 is set to be lower than that of the developing roller 25. Therefore, when the amount of intrusion is 1.0 mm, and the both surfaces move in the same direction at a peripheral speed ratio of 200%, the supply roller 24 rotates while being deformed significantly at the nip portion N. The peripheral speed difference is provided so that the supply roller which is deformed rotates faster than the developing roller which is not deformed.

Accordingly, the developing roller 25 receives a force in the direction in which the speed of rotation is constantly increased and is assisted to rotate by the supply roller which rotates at a peripheral speed higher than that of the developing roller 25.

As in the related art, in a case where the supply roller 24 rotates at 100 rpm, and the developing roller rotates at 100 rpm in the direction indicated by the arrow E in the drawing so that the surfaces of the respective rollers move in the opposite direction (rotate in the opposite directions), the supply roller 24 applies brakes on the rotation of the developing roller 25.

Provision of the force in the braking direction to the developing roller 25 accelerates stick-slip phenomenon between the photosensitive drum 1 and the developing roller 25.

The stick-slip phenomenon between the photosensitive drum and the developing roller is a phenomenon that the rotation of the developing roller is slowed by the friction with respect to the photosensitive drum. When a force in the direction of slowing the rotation of the developing roller is applied from the supply roller to the developing roller, if the stick-slip phenomenon between the photosensitive drum and the developing roller occurs, the rotation of the developing roller is further slowed. Consequently, the probability of occurrence of the banding on the image is increased.

In Example 1, the developing roller 25 receives a force in the direction in which the speed of rotation is constantly increased and is assisted to rotate by the supply roller which rotates at a peripheral speed higher than the developing roller 25. Therefore, even when the stick-slip phenomenon between the photosensitive drum and the developing roller is generated, the probability of occurrence of the banding on the image may be reduced.

Furthermore, in Example 1, a predetermined voltage is applied from a bias power source 60 (a bias application unit) on the supply roller 24, and the stabilization of the toner supply to the developing roller is achieved. Since the toner T having negative chargeability is used, a voltage Vrs of −500V is applied on the supply roller 24 so as to generate a minus electric field in the toner supply direction with respect to a voltage Vdc of −300V applied to the developing roller 25 as the developing bias.

Accordingly, the toner is stably supplied from the supply roller 24 to the developing roller 25 so that the density of the image may be satisfied. In addition, a state in which the toner exists stably between the supply roller 24 and the developing roller 25 rotating with a peripheral speed difference is ensured.

For example, when a voltage Vrs of −100V is applied to generate a plus electric field in the toner removing direction, a state in which no toner exists between the supply roller 24 and the developing roller 25 may occur. Since a frictional force between the supply roller 24 and the developing roller 25 with the toner interposed therebetween and the frictional force occurring when the supply roller 24 and the developing roller 25 rotate in direct contact with each other without the toner interposed therebetween are different, the influence of the rotation of the supply roller which increases the speed of rotation of the developing roller 25 may vary.

The case where no toner exists between the supply roller 24 and the developing roller 25 may occur depending on the image pattern.

Therefore, in Example 1, the occurrence of the banding is prevented by ensuring the stable existence of the toner between the supply roller 24 and the developing roller 25 by applying a bias voltage to the supply roller and the developing roller 25 so as to allow the generation of an electric field in the toner supply direction from the developing roller 25 to the supply roller 24 instead of the potential which generates an electric field in the toner removal direction from the developing roller 25 to the supply roller 24 or the same potential. In other words, the bias power source 60 applies a bias voltage to the supply roller 24 and the developing roller 25 so that the value obtained by subtracting the bias value applied to the developing roller from the vial value applied to the supply roller 24 becomes the same polarity as a legitimate charging polarity of the toner.

In particular, the reason why the probability of occurrence of the banding on the image is relatively high in the configuration in which the developing apparatus supplies the developer to the developer carrying member and the supply member against the gravitational force is that the toner can hardly exist stably around the supply roller. The toner around the supply roller drops due to the gravitational force, and hence the friction between the developing roller and the supply roller becomes an unstable state and the banding may occur easily although the lack of color density of the solid image does not occur.

The photosensitive unit 13 and the developing unit 4 come into contact with each other so that the developing roller 25 intrudes into the surface of the photosensitive drum 1 by 70 μm. In other words, the developing roller 25 forms a nip portion M (second nip portion) so as to sandwich the toner at a portion opposing the photosensitive drum 1. The photosensitive drum 1 rotates at 40 rpm in the direction indicated by the arrow A in the drawing, and the developing roller rotates at 100 rpm in the direction indicated by an arrow D in the drawing so that the surfaces of the respective rollers move in the same direction (the direction from down to up in Example 1). The peripheral speed of the developing roller and the peripheral speed of the photosensitive drum are 80 mm/sec. and 64 mm/sec., respectively. In other words, the peripheral speed ratio expressed by the peripheral speed of the developing roller/the peripheral speed of the photosensitive drum is 125%.

In Example 1, the difference of surface speeds and the peripheral speeds between the developing roller and the photosensitive drum is set to be 16 mm/sec. (in the contact developing system, in order to effectively reduce the stick-slip phenomenon between the photosensitive drum and the developing roller, the peripheral speed difference is preferably set to be 10 mm/sec. or larger. In Example 1, the hardness of the developing roller 25 is set to be lower than that of the photosensitive drum 1. Therefore, when the amount of intrusion is 70 μm, and the both surfaces move in the same direction at the peripheral speed ratio of 125%, the developing roller rotates while being deformed significantly. The peripheral speed difference is provided so that the developing roller which is deformed rotates faster than the photosensitive drum 1 which is not deformed.

With the configuration in which the hardness of the developing roller 25 is set to be lower than that of the photosensitive drum 1 so that the developing roller 25 rotates while being deformed more significantly than the photosensitive drum 1, the influence of the photosensitive drum with which the developing roller 25 rotates in contact may be maintained adequately while avoiding becoming too much.

By setting the surface roughness of the developing roller provided on the side where the peripheral speed is faster and deformable to be larger than the photosensitive drum, the deformation is performed further stable, and the rotation of the developing roller is further stabilized.

In Example 1, when developing and visualizing the electrostatic latent image formed on the photosensitive drum 1, the photosensitive drum 1 and the developing roller 25 are brought into abutment contact with each other, and are driven to rotate. The supply roller 24 and the developing roller 25 are rotated while forming the nip portion N (the portion of the supply roller and the developing roller that sandwich the toner). At this time, at the nip portion N and the nip portion M, the surfaces of the supply roller 24 and the developing roller 25 move in the same direction at the nip portion N, and the surfaces of the developing roller 25 and the photosensitive drum 1 move in the same direction at the nip portion M. The peripheral speed ratio expressed by the peripheral speed of supply roller/the peripheral speed of developing roller is set to be 200%, and the peripheral speed ratio expressed by the peripheral speed of the developing roller/the peripheral speed of the photosensitive drum is set to be 125%. By setting the relation such that the peripheral speed of the supply roller>the peripheral speed of the developing roller>the peripheral speed of the photosensitive drum, the rotation shake of the developing roller is prevented and occurrence of the banding may be prevented.

In addition, by setting the peripheral speed difference between the supply roller and the developing roller at the nip portion N and the peripheral speed difference between the developing roller and the photosensitive drum at the nip M to have a relationship of the peripheral speed difference between the supply roller and the developing roller>the peripheral speed difference between the developing roller and the photosensitive drum, the banding formed by the stick-slip phenomenon between the photosensitive drum and the developing roller may further be reduced. In particular, by setting the relationship of the peripheral speed differences as the peripheral speed difference between the supply roller and the developing roller>the peripheral speed difference between the developing roller and the photosensitive drum>10 mm/sec., the rotation shake of the developing roller by the stick-slip phenomenon between the photosensitive drum and the developing roller may further effectively be reduced.

Furthermore, the developing roller is configured to be softer than the photosensitive drum and deformable, and the supply roller is configured to be softer than the developing roller and deformable. In other words, by configuring the member on the side where the peripheral speed is higher at the nip portion to be softer and deformable, the rotation shake of the developing roller is prevented further effectively, and the banding may be prevented. Also, by configuring the member on the side where the peripheral speed is higher at the nip portion to have a larger surface roughness, the rotation shake of the developing roller is prevented further effectively, and the banding may be prevented.

As described above, in the configuration in which the toner is conveyed from the toner storage section arranged below the supply roller onto the supply roller, the surface of the developing roller moves faster than the surface of the photosensitive drum in the same direction as the surface of the photosensitive drum at the nip portion M, and the surface of the supply roller moves faster than the surface of the developing roller in the same direction as the surface of the developing roller at the nip portion N. Accordingly, the rotation shake of the developing roller is reduced, and the probability of occurrence of the banding on the image may be reduced.

Example 1 has been described thus far. In the embodiment described above, the image forming apparatus capable of forming color images has been exemplified as the image forming apparatus. However, the invention is not limited thereto. The image forming apparatus capable of forming monochrome images, for example, image forming apparatuses such as copying machines, facsimile apparatuses, and other image forming apparatuses such as multiple function processing machines having a combination of functions of these machines are also applicable, and the same effects may be obtained by applying the invention to the developing apparatuses in the image forming apparatuses as described above.

### Example 2

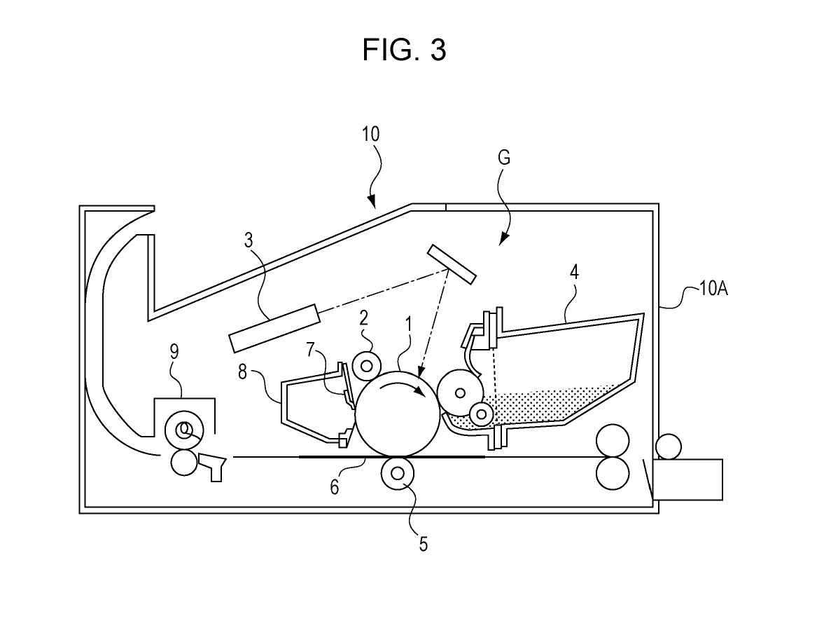

FIG. 3 is a cross-sectional view illustrating a configuration of an image forming apparatus 10 provided with a developing apparatus 504 according to Example 2 of the invention. The image forming apparatus 10 is an image forming apparatus using an electrophotographic image forming process. As illustrated in FIG. 3, the image forming apparatus 10 includes an image forming apparatus body (hereinafter, simply referred to as “apparatus body”) 10A, and includes an image forming portion G that forms an image provided in the interior of the apparatus body 10A. The image forming portion G includes the photosensitive drum 1 as the “image carrying member”, and the primary transfer rollers 5 as a “transfer apparatus”. The photosensitive drum 1 and the developing apparatus 504 may be included in the process cartridge and have a configuration demountably integrated in the apparatus body 10A as the process cartridge.

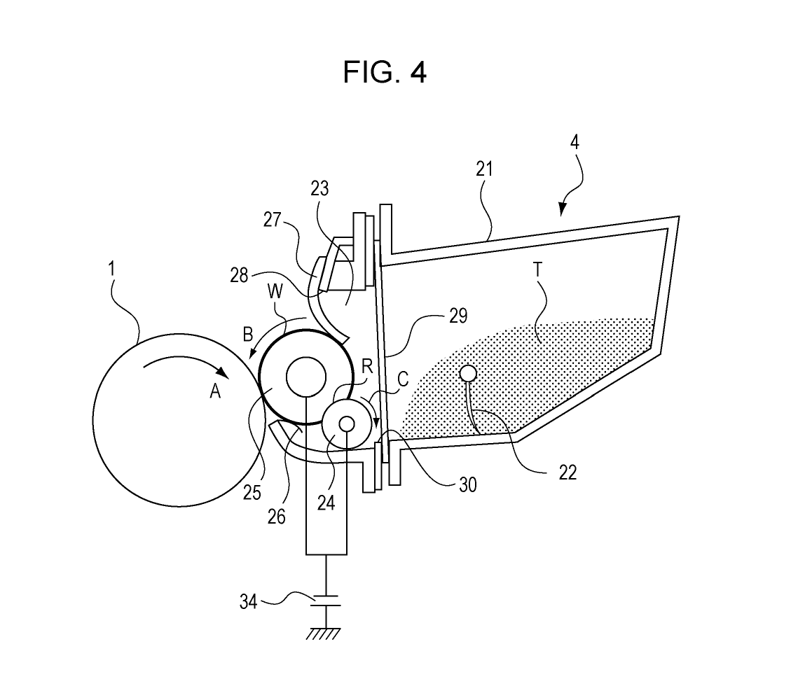

Referring now to FIG. 3, the image forming operation by the image forming apparatus will be described. As illustrated in FIG. 3, the photosensitive drum 1 as the image carrying member rotates in the direction indicated by an arrow. First of all, the photosensitive drum 1 is uniformly charged by the charging roller 2 as a charging apparatus. Subsequently, the photosensitive drum 1 is exposed by a laser beam from the scanner unit 3 as the exposing unit, and an electrostatic latent image is formed on the surface thereof. The electrostatic latent image is developed by the developing apparatus 504 in which the toner T is stored, and is visualized as a toner image. As the toner T (see FIG. 4), non-magnetic one-component toner as “one-component developer” is used.

The visualized toner image on the photosensitive drum 1 is transferred to a recording medium 6 as a transfer member by the primary transfer rollers 5. The residual toner remaining on the photosensitive drum 1 without being transferred is removed by the cleaning blade 7 as the cleaning member, and is stored in a waste tone container 8. The cleaned photosensitive drum 1 repeats the above-described action to perform the image formation. In contrast, the recording medium 6 to which the toner image is transferred is discharged to the outside after having fixed thereto by the fixing apparatus 9.

FIG. 4 is a cross-sectional view illustrating a configuration of the developing apparatus 504. As illustrated in FIG. 4, the developing apparatus 504 includes the toner storage chamber 21 and a developing chamber 23. The toner storage chamber 21 as the “developer container” is a container for storing the toner T as the “developer”. The developing chamber 23 is a chamber in which the electrostatic latent image on the surface of the photosensitive drum 1 is developed by the toner T conveyed from the toner storage chamber 21. An opening 30 which allows passage of the toner T is formed between the toner storage chamber 21 and the developing chamber 23. The stirring conveying member 22 as a “conveying member” configured to convey the toner T toward the opening 30 by rotating is arranged in the interior of the toner storage chamber 21. A seal member 29 is adhered on the opening 30.

The non-magnetic one-component toner is filled in the toner storage chamber 21. The stirring conveying member 22 rotating in a constant direction is provided in the interior of the toner storage chamber 21. The stirring conveying member 22 supplies the toner in the interior of the toner storage chamber 21 toward the developing chamber 23 adjacent to the toner storage chamber 21.

The seal member 29 is arranged so as to cover the opening 30 between the toner storage chamber 21 and the developing chamber 23. The seal member 29 prevents the toner stored in the toner storage chamber 21 before usage of the developing apparatus 504 from flowing into the interior of the developing chamber 23. The seal member 29 is configured to prevent the toner from unintentionally flowing out from the developing apparatus 504 due to the vibrations or the like at the time of conveyance and contaminating a user, the developing apparatus 504, and hence the apparatus body 10A. In this manner, the seal member 29 is configured to seal so as to prevent the toner T from flowing from the toner storage chamber 21 to the developing chamber 23 before the image formation, and is removed at the time of image formation.

There are following two configurations in which the seal member 29 is used. A first configuration is that a grip coupling to the seal member 29 is exposed from a cover of the developing apparatus 504, so that the user pulls out the seal member 29 by a manual operation before usage of the developing apparatus 504. A second configuration is that an internal mechanism of the developing apparatus 504 automatically pulls out the seal member 29 at the time of driving the developing apparatus 504. Any one of configurations may be employed.

The developing roller 25, the supply roller 24, the developing blade 27, and a leakage-preventing sheet 26 are arranged in the interior of the developing chamber 23. The developing roller 25 as the “developer carrying member” is a roller coming into contact with the photosensitive drum 1, and rotating while carrying the toner T in the interior of the toner storage chamber 21, and moving the toner T to the photosensitive drum 1. The supply roller 24 as the “supply member” is a roller coming into contact with the developing roller 25 and rotating while supplying the toner T to the developing roller 25. The developing roller and the supply roller 24 are set so that the both surfaces rotate in the same direction (rotates in the with-direction) at a contact portion R therebetween.

The developing blade 27 is a blade formed of phosphor bronze, and urethane rubber coming in sliding contact with the developing roller 25 at one end portion thereof, and configured to coat the toner supplied around the developing roller 25 into a thin layer. The leakage-preventing sheet 26 is a member configured to cover a gap of the developing chamber 23 below the developing roller 25. Here, a non-magnetic toner having negative chargeability as one component developer is used.

The developing roller 25 rotates in the direction indicated by the arrow B. Here, the developing roller 25 having a diameter (φ) of 16 mm is used. The developing roller 25 has a configuration in which a silicon rubber is formed as a basic layer on the periphery of a conductive core metal having a diameter (φ) of 8 mm, and acrylic urethane-based rubber is coated on the surface thereof. The volume resistivity is 10×10⁻⁴ to 10×10⁻¹²Ω. Here, the surface cell diameter of the supply roller 24 is set to be 50 to 1000 μm.

The supply roller 24 is arranged below the developing roller 25 so as to come in contact thereto. The supply roller 24 rotates in the direction indicated by an arrow C. The supply roller 24 is a roller having foaming properties and resiliency. Here, the supply roller 24 having a diameter (φ) of 12 mm is used. The supply roller is a urethane sponge roller provided with a urethane sponge layer on a conductive core metal having a diameter (φ) of 6 mm, and configured to supply toner to the developing roller 25 and remove the undeveloped toner.

Here, an experiment was conducted on the assumption that the developing roller 25 was formed to have the diameter of 16 mm as described above and rotated at a number of rotations of 100 rpm, and the supply roller 24 was formed to have the diameter of 12 mm as described above and rotated at a number of rotations of 200 rpm. In this case, the supply roller 24 was set to rotate 1.5 turns until the developing roller 25 rotates 360°.

However, the invention is not limited thereto, and the supply roller 24 may be set to rotate at least 360° until the developing roller 25 rotates 360°. By setting the supply roller 24 to rotate at least 360° while the developing roller 25 rotates 360° at the time of initial driving of the developing apparatus 504, powder applied to the developing roller 25 may be spread over the entire surface of the supply roller 24. In this configuration, the powder is adhered on the surface of the supply roller 24 and functions as lubricant between the supply roller 24 and the developing roller 25, so that generation of fragments of the supply roller 24 or breakage of the developing apparatus 504 and the image forming apparatus 10 may be prevented.

Here, a case where the supply roller 24 is set to rotate 360° until the developing roller 25 rotates 360° will be considered. Here, although it is only an example, the developing roller 25 is formed to have the diameter of mm as described above and rotates at a number of rotations of 100 rpm, and the supply roller 24 is formed to have the diameter of 12 mm as described above and rotates at a number of rotations of 134 rpm. Therefore, in order to allow the supply roller 24 to rotate 360° or more until the developing roller 25 rotates 360°, the supply roller 24 may be rotated at 134 rpm or higher when the developing roller 25 rotates at 100 rpm.

The distance between the core metal of the developing roller 25 and the core metal of the supply roller 24 is 10.5 mm. The urethane sponge layer of the supply roller 24 is intruded into the surface of the developing roller 25 by 1.5 mm. The volume resistivity of the sponge layer used in the supply roller 24 is on the order of 10×10⁻⁴ to 10×10⁻¹² Ω·cm. Developing Apparatus at the time of Factory Setting

Here, from the beginning of the manufacture, powder W having a charging capacity of 0 or the powder W charged in the same polarity as the toner T and having a charging capacity whose absolute value is equal to or lower than the absolute value of the charging capacity of the toner T is retained (applied) on the surface of the developing roller 25. In other words, the powder W is retained on the surface of the developing roller 25 in a state in which the developing apparatus is no used. Accordingly, the excessive charging of the toner at the initial stage of usage of the developing apparatus 504 or transfer of the applied powder to a non-image portion (so-called positive fog) is prevented. In contrast, the surface of the supply roller 24 is brought into a state in which the powder W is not retained.

In other words, if the powder is charged in a polarity opposite from that of the toner, the toner generates triboelectric charging with respect to the developing roller 25 and also with respect to the developing blade 27 which controls the toner, and in addition, with respect to the powder, so that the toner is excessively charged. In this case, the toner can hardly leave the developing roller 25, and hence the image density is lowered. Also, even though the powder has characteristics to be charged in the same polarity as the toner, if the absolute value is excessively increased in comparison with that of the toner, the reduction of the triboelectric charging amount of the toner or the reverse charging may occur. In such a case, fog may occur. The powder having a charging capacity equivalent to that of the toner in absolute value preferably includes those having charging capacities up to 1.5 times that of the toner.

When the developing roller 25 is formed of rubber, and the supply roller 24 is formed of sponge, the following results are expected. (1) When the powder W is applied to the surface of the developing roller 25, since the material of the surface of the developing roller 25 is rubber, the amount of the powder W which can be retained on the surface of the roller is smaller than the case where the powder W is applied to the surface of the supply roller 24. Therefore, when the developing roller 25 is assembled to the developing chamber 23, the amount of the powder W dropping off the surface of the developing roller 25 is small.

(2) In contrast, when the powder W is applied to the surface of the supply roller 24, since the material of the surface of the supply roller 24 is sponge, the amount of the powder W which can be retained on the surface of the roller is larger than the case where the powder W is applied to the surface of the developing roller 25. Therefore, when the supply roller 24 is assembled to the developing chamber 23, the amount of the powder W dropping off the surface of the supply roller 24 is large. In particular, since the powder W is sucked into the interior of the supply roller 24, the amount of the powder W dropping off is increased. From these reasons, it may be said that the higher assembleability of the developing apparatus 504 is achieved by applying the powder W to the developing roller 25 and assembling the developing roller 25 to the developing chamber 23 in terms of assembleability of the developing apparatus 504 than applying the powder W to the supply roller 24 and assembling the supply roller 24 to the developing chamber 23.

However, it may also be said that the amount of the powder W which can be applied to the surface of the developing roller 25 is smaller than the amount of the powder W which can be applied to the surface of the supply roller 24, the initial drive torque can easily be increased until the toner T is conveyed from the toner storage chamber 21 to the supply roller 24. Therefore, it may be said that probability of formation of the fragments of the supply roller 24 or breakage of the drive system of the developing apparatus 504 or the image forming apparatus 10 is high. This problem regarding the torque is solved because the surfaces of the developing roller 25 and the supply roller 24 are set to be rotated in the same direction at the contact portion R as described above.

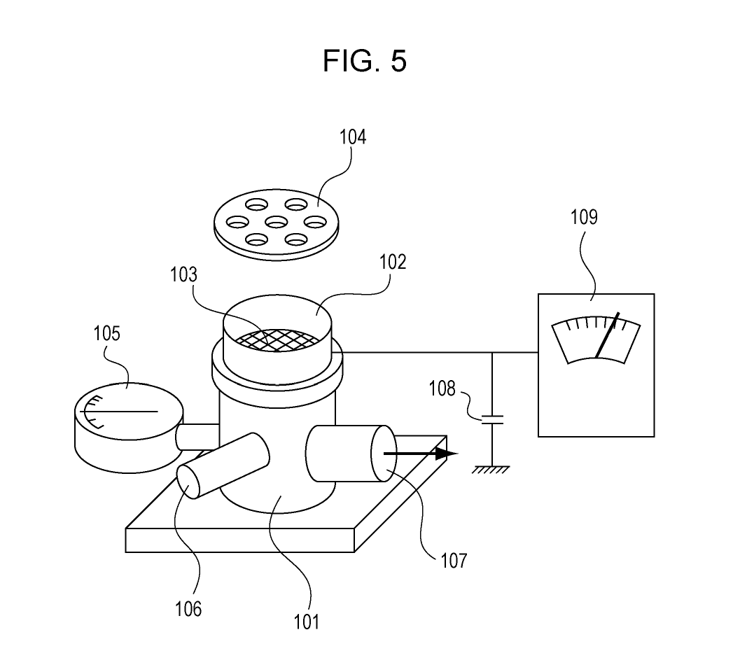

FIG. 5 is a perspective view of a charging amount measuring apparatus configured to measure the charging amount of the powder. The charging capacity of the powder is controlled as described below. First of all, a composite of powder whose triboelectric charging amount is to be measured and iron powder (EFV200/300, manufactured by Powdertech) is put into a polyethylene bottle having a capacity of 50 ml, and is shaken by hand by 500 times. Approximately 0.5 g of the composite is put into a metallic measuring container 102 having a 500-mesh screen 103 on the bottom, and the measuring container 102 is covered with a metallic lid 104. The weight of the entire measuring container at this time is measured and set the measured value as W1 (g).

Subsequently, an aspirator 101 (a portion in contact with the measuring container 102 is at least formed of an insulating member) sucks in from a suction port 107 (an air amount adjusting value 106 is adjusted to set the pressure of a vacuum gauge 105 to 250 mmAq). In this state, suction is continued for at least one minute, preferably two minutes to suck and remove the powder. The potential of a potentiometer 109 at this time is expressed by V (volt). Here, the capacity of a capacitor 108 is expressed by C (μF). Subsequently, the weight of the entire measuring container 102 after the suction is measured and expressed as W2 (g). The triboelectric charging amount (μC/g) of this powder is calculated by the following expression (1).

Triboelectric charging amount of powder=C×V/(W1−W2) (1)

The powder desirably has a diameter which provides good slipping properties with respect to the supply roller 24 and the developing roller 25 (developing sleeve), and preferably has a diameter which is substantially the same as the diameter of the toner, or at least 1/100. The diameter is evaluated by, for example, a mean volume diameter. In other words, Coulter Counter TA-II type (manufactured by Beckman Coulter, Inc.) is used as a measuring apparatus. Then, an interface (manufactured by Nikkaki-Bios) that outputs the mean volume distribution and CX-1 personal computer (manufactured by CANON KABUSHIKI KAISHA) are connected, and electrolysis solution is obtained by adjusting 1% NaCl solution using first class sodium chloride.

As a measuring method, 0.1 to 5 ml of a surface acting agent, preferably, sodium alkylbenzene sulfonate, is added to 100 to 150 ml of the above-described electrolysis solution, and then 0.5 to 50 mg of a sample to be measured is added thereto. The electrolysis solution in which the sample is suspended is subject to a dispersion treatment by an ultrasonic disperser for approximately one to 3 minutes, and the mean value diameter is obtained with the Coulter Counter TA-II type.

In Example 2 and the comparative example, deliberation is performed using non-magnetic one component toner, and the results are written in a tabular form.

In the evaluation of breakage of the supply roller etc., “A” denotes that there was no breakage and “B” denotes that there was breakage. In the evaluation of assembleability, “A” denotes that good assembleability is ensured, “B” denotes that the assembleability is lower than “A”, and “C” denotes that the assembleability is further lower than “B”.

TABLE 1

| | | | | DAMAGE | |
|---|---|---|---|---|---|
| | ROLLER FOR | AMOUNT OF | | OF | |
| | APPLYING POWDER | POWDER TO | STATIC | SUPPLY | |
| | AT THE TIME OF | BE | TORQUE | ROLLER, | |
| | MANUFACTURE | APPLIED [mg] | [kgf · cm] | etc. | ASSEMBLEABILITY |
| COMPARATIVE | SUPPLY ROLLER | 0 | 2.3 | B | A |
| EXAMPLE 1 | | | | | |
| COMPARATIVE | DEVELOPING | 50 | 2.2 | B | A |
| EXAMPLE 2 | ROLLER | | | | |
| COMPARATIVE | SUPPLY ROLLER | 800 | 1.2 | A | C |
| EXAMPLE 3 | | | | | |
| COMPARATIVE | SUPPLY ROLLER | 200 | 1.8 | B | B |
| EXAMPLE 4 | | | | | |
| EXAMPLE 2 | DEVELOPING | 50 | 0.75 | A | A |
| | ROLLER | | | | |

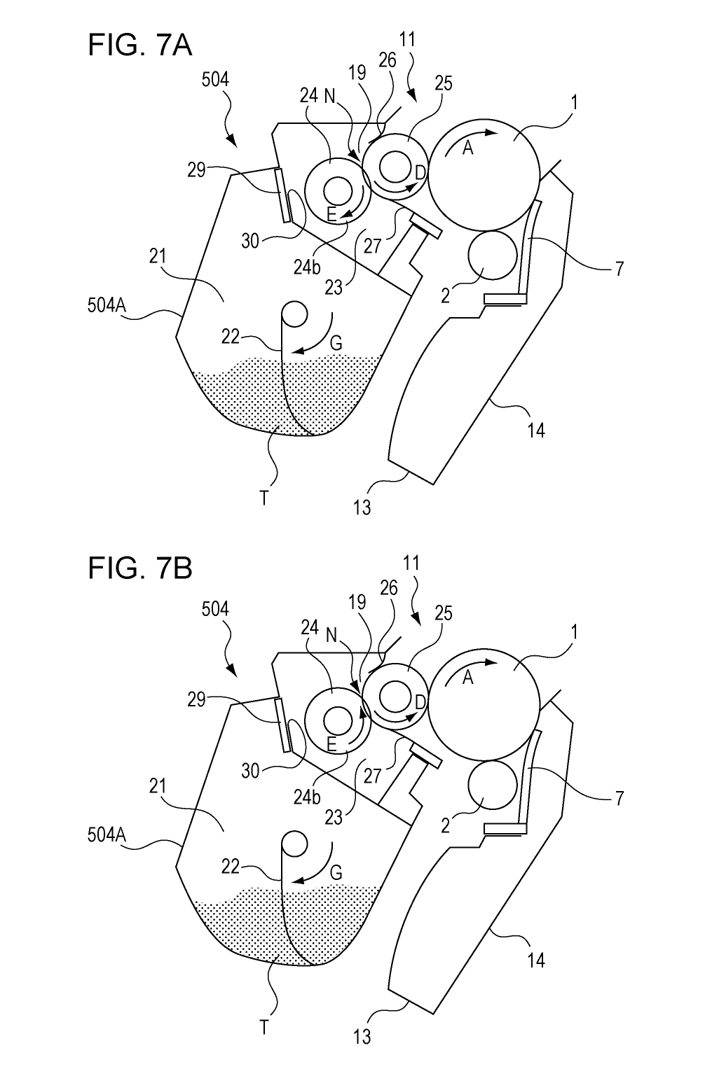

In the comparative examples, the supply roller 24 and the developing roller 25 rotated so that the surfaces come into contact with each other at the nip portion N and move in the opposite directions (counter direction) from each other. At this time, the material of the supply roller 24 was polyurethane foam having a surface cell diameter of 300 μm and an outer diameter of 12.0 mm. The amount of intrusion of the supply roller 24 into the developing roller 25 was 1.5 mm, and the direction of rotation of the supply roller 24 was as indicated by an arrow in FIG. 7B. A static torque of the developing apparatus 504 at the time of normal usage was 1.0 kgf·cm to 1.3 kgf·cm.

In Table 1, the breakage of the supply roller 24 etc. was observed. However, the reason why the supply roller 24 was exemplified was that the supply roller 24 was susceptible to the torque in comparison with other portions because the supply roller 24 was formed of a material softer than that of the developing roller 25 such as sponge. However, since the item was specified as “SUPPLY ROLLER etc.”, breakage of members other than the supply roller 24 was also observed.

First of all, the description of Comparative Example 1 in Table 1 will be described. In Comparative Example 1, the powder was not applied to the supply roller and the static torque of the developing apparatus 504 was 2.3 kgf·cm. The static torque used in this case was a torque of the developing roller 25 using the static coefficient of friction at the time of initial driving. In this case, lost tooth (breakage of gear or the like) occurred at a driving portion from the apparatus body 10A to the developing apparatus 504. The reason is that in order to secure a sufficient amount of toner in the interior of the developing chamber 23, the rotation of the stirring conveying member 22 was necessary, and the initial drive torque was increased because the toner was not flowed sufficiently into the developing chamber 23 only by pulling-out of the seal member 29. When the image was formed by using the developing apparatus 504, there appeared several color-missing stripes on the image on the sheet.

Subsequently, the description of Comparative Example 2 in Table 1 will be described. In Comparative Example 2, 50 mg of toner was carried on the developing roller 25 and the static torque of the developing apparatus 504 was 2.2 kgf·cm. The toner in the developing chamber 23 at this time was assumed to be only the toner applied to the surface of the developing roller 25. In this case, in the same manner as Comparative Example 1, teeth loosing occurred at the driving portion from the apparatus body 10A to the developing apparatus 504.

Subsequently, the description of Comparative Example 3 in Table 1 will be described. In Comparative Example 3, 800 mg of toner was carried on the supply roller and the static torque of the developing apparatus 504 was 1.2 kgf·cm. The toner in the developing chamber 23 at this time was assumed to be only the toner applied to the supply roller 24. In this case, breakage of the supply roller 24 or the like did not occur, and even when the image was formed by using the developing apparatus 504, no color-missing stripe was appeared on the image on the sheet. However, since as much as 800 mg of toner was applied to the supply roller 24, it takes a long time to apply the toner to the supply roller 24 at the time of manufacture, and hence a tact time is elongated (working efficiency is lowered). Some of the toner dropped when arranging the supply roller 24 in the developing apparatus 504, and lowering of the assembleability due to the contamination of the outside and inside of the developing apparatus 504 was observed.

Subsequently, the description of Comparative Example 4 in Table 1 will be described. In Comparative Example 4, 200 mg (the amount of toner was reduced for avoiding the lowering of assembleability and the elongation of the tact time as in Comparative Example 3) of toner was carried on the supply roller 24 and the static torque of the developing apparatus 504 was 1.8 kgf·cm. The toner in the developing chamber 23 at this time was assumed to be only the toner applied to the supply roller 24. In this case, breakage of the supply roller 24 or the like occurred and the assembleability was slightly lowered. The power consumption at the time of activation was increased.

Subsequently, the description of EXAMPLE 2 in Table 1 will be described. In the example of experiment in Example 2, the powder was interposed at a contact portion between the supply roller 24 and the developing roller 25, so that the slipping properties of the both members were improved. Also, the supply roller 24 and the developing roller 25 rotated so that the surfaces come into contact with each other at the nip portion N and move in the same direction (the direction moving from down to up in FIG. 4). At this time, in the same manner as Comparative Examples, the material of the supply roller 24 was polyurethane foam having a surface cell diameter of 300 μm and an outer diameter of 12.0 mm. The amount of intrusion of the supply roller 24 into the developing roller 25 was set to 1.5 mm.

The number of rotations of the supply roller 24 was set to 200 rpm, and the number of rotations of the developing roller 25 was set to 100 rpm. In addition, the supply roller 24 was set to rotate 1.5 turns until the developing roller 25 rotates 360°. These values were set just for the experiment, and the contents of the invention are not limited to these values.

By setting the supply roller 24 to rotate at least 360° while the developing roller 25 rotates 360° when the number of revolutions are set as described above, powder applied to the developing roller 25 may be spread over the entire surface of the supply roller 24. In other words, with the setting as described above, the supply roller 24 rotates 360° C. until the developing roller 25 rotates 360° if the number of rotations of the supply roller 24 is 134 rpm or larger. With the setting as described above, the powder is adhered on the surface of the supply roller 24 and functions as lubricant between the supply roller 24 and the developing roller 25, so that prevention of generation of chips of the supply roller 24 or breakage of the developing apparatus 504 and the image forming apparatus 10 is realized. A static torque of the developing apparatus 504 at the time of normal usage is 0.65 kgf·cm to 0.85 kgf·cm.

The contents of Example 2 in Table 1 will be described in detail below. Here, 50 mg of toner was carried on the supply roller 25, the toner was not carried on the supply roller 24, and the static torque of the developing apparatus 504 was 0.75 kgf·cm. The toner in the developing chamber 23 at this time was assumed to be only the toner applied to the developing roller 25. In this case, a point when the static torque of the developing apparatus 504 described above becomes ½ or more in comparison with Comparative Examples, whereby a point when the power consumption is lowered to a half or below were important. Also, breakage of the supply roller 24 or the like did not occur, and even when the image was formed by using the developing apparatus 504, no color-missing stripe was appeared on the image on the sheet. In addition, the assembleability was also improved. Although a case where the non-magnetic one-component toner was used has been described in conjunction with the above-described experiment, the same effect was obtained when magnetic one-component toner was used.

In Example 2, the exemplified printer was a monochrome printer. However, the toner may be set to the same color as the toner color in the interior of the developing apparatus 504 when applying the toner to the developing roller 25. However, in the case of the color printer, a toner application process or the developing apparatuses 504 are required for each color, and the manufacturing cost may be increased.

Therefore, the toner of a color having a highest brightness among the used toners T may be applied to the developing roller 25 for each of the developing apparatuses 504 for all colors used in the color printer. In this configuration, reduction of the manufacturing cost is achieved without causing the color variations in the initial image formation. It is needless to say that the color reproducibility is impaired the least when the colorless toner having no pigment in a toner resin is used as an application agent. From these reasons, the powder W is preferably the colorless powder W and, alternatively, when the toner T is used, the toner T having the highest brightness from among the used toners T is preferably selected. In Example 2, a spectral colorimeter 938 manufactured by X-Rite was used as a measuring instrument for measuring the brightness of the toner.

Accordingly, the powder W to be applied to the developing roller 25 will be described. Powder which is used for controlling the charging capability or flow property, or environmental stability of the toner is used as the powder to be applied to the developing roller 25. The reason why the powder as described above are used is that there is no cost generated for manufacturing the toner because it is a row material of the toner, and reduction of costs is achieved as the powder to be applied to the developing roller 25.

Here, for example, resin powder, that is, fine powder of vinylidene fluoride or fine powder of polytetrafluoroethylene may be employed as such the powder. Alternatively, metal salt of fatty acids, that is, zinc stearate, calcium stearate, or lead stearate is also applicable. Alternatively, the powder W may be the toner T or metal oxide. In other words, zinc oxide powder, silica, alumina, titanium oxide, tin oxide, and furthermore, the silica surface-treated by silane coupling agent, titanium coupling agent, or silicon oil are exemplified. However, all of the types of the powder cannot be used as the application agent to be applied to the developing roller 25. As the powder W, the one having least color is preferable.

In Example 2, toner having negative charging characteristics was used, and a several types of powder were used as the developing roller application agent were used. Powder A has positive charging characteristics, powder B is little charged by itself, powder C is charged at a negative polarity, but weaker than the charge of the toner, and powder D is charged at a negative polarity stronger than the charge of the toner. The charging capacities (saturated charging amount) of the toner and the respective types of powder were as follows.
Toner: −10 to −30 μC/g
Powder A (surface-treated silica): +50 to +100 μC/g
Powder B (styrene acrylic resin): 0 to −10 μC/g
Powder C (resin composite of polyester and polyethylene): −10 to −30 μC/g
Powder D (surface-treated silica): −80 to −200 μC/g

Four types of powder as described above were applied to the developing roller 25 and the developing apparatus 504 was driven. In this case, first of all, the powder D was electrostatically adsorbed firmly to the surface of the developing roller 25. The toner was prevented from being charged by the sliding friction, and could hardly be provided with a reflecting force with respect to the developing roller 25, whereby the uniform toner coat was not formed. As it is understood from the description above, the absolute value of the charging capacity of the powder D (80 to 200 μC/g) was set to be larger than the absolute value of the charging capacity of the toner (10 to 30 μC/g).

In the case of the powder A, the toner and the external additive were adsorbed to each other by the electrostatic adsorption, and the toner could not have its own charging force and the positive fog was caused. As it is understood from the description above, the absolute value of the charging capacity of the powder A (50 to 100 μC/g) was set to be larger than the absolute value of the charging capacity of the toner (10 to 30 μC/g).

The powder B and the powder C did not cause any problem as in the case where the toner was applied to the supply roller 24. As it is understood from the description above, the absolute value of the charging capacity of the powder B (0 to 10 μC/g) was set to be equal to or smaller than the absolute value of the charging capacity of the toner (10 to 30 μC/g). The absolute value of the charging capacity of the powder C (10 to 30 μC/g) was set to be equal to the absolute value of the charging capacity of the toner (10 to 30 μC/g).

Here, when the experiment is conducted as the charging capacity of the used powder was −15 μC/g when the charging capacity of the used toner was −10 μC/g, no problem was occurred as in the case where the toner was applied to the developing roller 25. Also, when the experiment is conducted as the charging capacity of the used powder was −29 μC/g when the charging capacity of the used toner was −18 μC/g, no problem was occurred in the same manner. In other words, if the powder has approximately 1.5 times the charging capacity of the toner, that is, the equivalent charging capacity to that of the toner, the charging capacity of the toner is not remarkably impaired as in the case of the powder (powder D) which is charged excessively in comparison with the charging capacity of the toner, so that no problem arises.

### Example 3

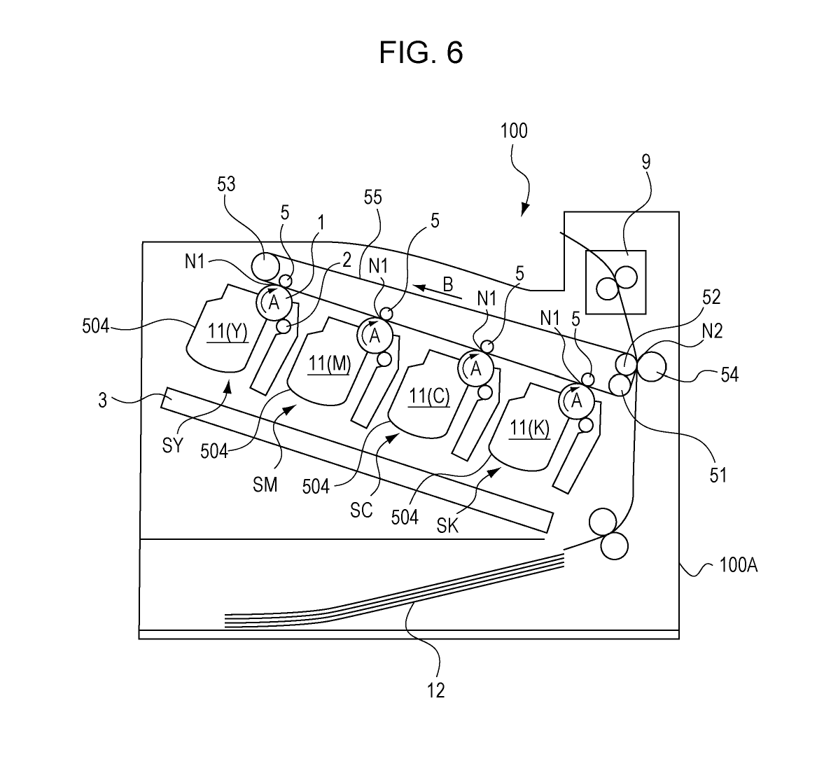

FIG. 6 is a cross-sectional view illustrating a configuration of the image forming apparatus 100 provided with the developing apparatus 504 of Example 3. The same configurations and the effects of the developing apparatus 504 of Example 3 as the developing apparatus 504 of Example are denoted by the same reference numerals and the description will be omitted as needed. Since the configuration in Example 3 may also be applied to the image forming apparatus as that in Example 2, part of the description of the image forming apparatus is omitted. The characteristics of the developing apparatus 504 of Example are following points. The first point is a point in which the developing chamber 23 is arranged on the toner storage chamber 21. The second point is a point in which if the seal member 29 is peeled off, the toner T is scooped up from the interior of the toner storage chamber 21 through the opening 30 to the interior of the developing chamber 23 by the activation of the stirring conveying member 22.

As illustrated in FIG. 6, the image forming apparatus 100 includes the apparatus body 100A. The apparatus body 100A includes first, second, third, and fourth image forming portions SY, SM, SC, and SK configured to form images of respective colors; yellow (Y), magenta (M), cyan (C), and black (K) arranged in the interior thereof as a plurality of image forming portions. In Example 3, the configuration and the action of the first to fourth image forming portions SY, SM, SC, and SK are substantially the same except that the colors of the images to be formed are different. Therefore, in the following description, suffix alphabets Y, M, C, and K are omitted and general description is given in order to indicate that the description is applied to any one of those components provided for four colors unless otherwise discrimination is needed.

The part of the image forming portion S constitutes the cartridge 11. The cartridge 11 is configured to be demountably mounted on the apparatus body 100A via a mounting device such as a mounting guide or a positioning member provided on the apparatus body 100A. In Example 3, all the respective cartridges 11 for the respective colors have the same shape, and store yellow (Y) toner, magenta (M) toner, cyan (C) toner, and black (K) toner, in the interiors of the cartridges 11 respectively.

The image forming portion S includes the photosensitive drum 1. The charging roller 2, the scanner unit 3, and the developing apparatus 504 are arranged on the periphery of the photosensitive drum 1. The intermediate transfer belt 55 is arranged above the photosensitive drums 1. The intermediate transfer belt 55 is stretched around the secondary transfer opposed roller 52, the drive roller 51, and the driven roller 53. Furthermore, the primary transfer rollers 5 opposing the photosensitive drums 1 with the intermediate transfer belt interposed therebetween is arranged above the photosensitive drum 1.

A bundle of the recording material 12 is arranged on the lower side of the interior of the apparatus body 100A. The secondary transfer roller 54 is arranged at a position opposing the secondary transfer opposed roller 52 with the intermediate transfer belt 55 interposed therebetween. In addition, the fixing apparatus 9 for fixing a developer image onto the recording material 12 is arranged on the downstream side of the nip between the secondary transfer roller 54 and the secondary transfer opposed roller 52 in the direction of conveyance of the sheet.

In Example 3, the developing apparatus 504 uses toner, which is non-magnetic one-component developer as developer. In Example 1, the developing apparatus 504 is configured to perform the invert developing by bringing the developing roller (described later) as a developer carrying member into contact with the photosensitive drum 1. In other words, in Example 3, the developing apparatus 504 develops the electrostatic image by causing the toner charged into the same polarity as the polarity at which the photosensitive drum 1 is charged (negative polarity in Example 3) to adhere portions where the charge is attenuated by the exposure on the photosensitive drum 1 (the image portion, the exposed portion).

FIG. 7A is a cross-sectional view illustrating the configuration of the cartridge 11. FIG. 7B is a cross-sectional view illustrating the configuration of the cartridge 11 of Comparative Example 5. FIG. 7A and FIG. 7B are different from each other in that the direction of rotation of the supply roller 24 is opposite. As illustrated in FIG. 7A, the cartridge 11 is composed of the photosensitive unit 13 including the photosensitive drum 1, and the developing apparatus 504 (developing unit) including the developing roller 25 integrated with each other.

The photosensitive unit 13 includes the cleaning frame body 14 as a frame body configured to support the respective components in the photosensitive unit 13. The photosensitive drum 1 is rotatably mounted on the cleaning frame body 14 via a bearing, not illustrated.

The photosensitive drum 1 rotates in accordance with the image forming operation by the drive force of the drive motor as the drive unit (the drive source), not illustrated, in the direction indicated by the arrow A in the drawing (clockwise) transmitted to the photosensitive unit 13. The photosensitive unit 13 includes the cleaning blade 7 and the charging roller 2 arranged so as to come into contact with the peripheral surface of the photosensitive drum 1. The residual toner removed from the surface of the photosensitive drum 1 by the cleaning blade 7 is dropped and stored in the cleaning frame body 14. The charging roller 2 as the charging unit is driven to rotate by pressure-contact of the roller portion of the conductive rubber with the photosensitive drum 1.

The developing apparatus 504 includes a developing frame member 504A as a frame member configured to support respective components in the developing apparatus 504. In the interior of the developing apparatus 504A, the toner storage chamber 21 and the developing chamber 23 are partitioned. The developing chamber 23 is arranged perpendicularly above the toner storage chamber 21.

In the interior of the toner storage chamber 21, the stirring conveying member 22 is rotatably supported and the stirring conveying member 22 stirs the toner in the interior of the toner storage chamber 21 and conveys the same. The developing roller 25 and the supply roller 24 are rotatably arranged in the interior of the developing chamber 23. In addition, the opening 30 which allows passage of the toner is formed between the toner storage chamber 21 and the developing chamber 23, and the seal member 29 is adhered to the opening 30. When forming the image, the seal member 29 is peeled off from the opening 30, so that the passage of the toner is allowed. A proximal portion of the developing blade 27 is mounted on a lower edge portion of another opening of the developing chamber 23 and a distal end portion of the developing blade 27 is in contact with the surface of the developing roller 25.

In this case as well, the developing roller 25 and the supply roller 24 are set to rotate in the same direction at the position of the contact portion. In other words, the developing roller 25 rotates in the direction indicated by the arrow D, and the supply roller 24 rotates it the direction indicated by the arrow E. Here, the cartridge 11 having the photosensitive unit 13 and the developing apparatus 504 integrated with each other is employed. However, the respective units may be separately provided.

### Developing Apparatus at the Time of Factory Setting

In Example 3, in the same manner as Example 2, the seal member 29 prevents the toner in the toner storage chamber 21 before usage of the developing apparatus 504 from flowing into the interior of the developing chamber 23. The seal member 29 is configured to prevent the toner from unintentionally flowing out from the developing apparatus 504 due to the vibrations at the time of transportation of the developing apparatus 504 and contaminating the user, the developing apparatus 504, and the image forming apparatus 100.

### Developing Apparatus at User

In Example 3 and Comparative Example 5, deliberation is performed using non-magnetic one component toner as the powder to be applied, and the results are written in Table 2 in a tabular form. However, in the same manner as Example 2, the powder to be applied is not limited to the non-magnetic one-component toner.

TABLE 2

| | ROLLER FOR | | DURATION OF | | | DAMAGE | |
|---|---|---|---|---|---|---|---|
| | APPLYING | AMOUNT OF | ROTATION | | | OF | |
| | POWDER AT | POWDER TO | WITHOUT | | STATIC | SUPPLY | |
| | THE TIME OF | BE APPLIED | TONER | | TORQUE | ROLLER, | |
| | MANUFACTURE | [mg] | SUPPLY | | [kgf · cm] | etc. | ASSEMBLEABILITY |
| COMPARATIVE | SUPPLY | 300 | 10 | seconds | 1.2 | A | C |
| EXAMPLE 5 | ROLLER | | 2 | minutes | 1.6 | C | |
| | | | 3 | minutes | 2.2 | B | |
| EXAMPLE 3 | DEVELOPING | 0.05 | 10 | seconds | 0.75 | A | A |
| | ROLLER | | 2 | minutes | 1.1 | A | |
| | | | 3 | minutes | 1.4 | A | |

In the Comparative Example 5, the supply roller 24 and the developing roller 25 rotate respectively so that the surfaces thereof are in contact with each other by a nip portion N and move in the opposite directions from each other. At this time, the material of the supply roller 24 is polyurethane foam having a surface cell diameter of 300 μm and an outer diameter of 12.0 mm. The amount of intrusion of the supply roller 24 into the developing roller 25 is 1.5 mm, and the supply roller 24 rotates as indicated by the arrow E in FIG. 7B. The static torque of the developing apparatus 504 at the time of normal usage is 1.0 kgf·cm to 1.3 kgf·cm.

Here, the description of Comparative Example 5 in Table 2 will be described. In Comparative Example 5, 300 mg of toner was carried on the supply roller 24. In addition, the following conditions were set. When the developing roller 25 and the supply roller 24 were rotated in a state in which no toner was supplied from the toner storage chamber 21, increase in static torque is seen. When the rotating time is 10 seconds in a state in which no toner is supplied, the static torque of the developing apparatus 504 was 1.2 kgf·cm. Then, when the rotating time in a state in which no toner was supplied was elongated to two minutes, the static torque of the developing apparatus 504 was increased to 1.6 kgf·cm, and the slight breakage of the supply roller 24 or the like was generated. Furthermore, when the rotating time in a state in which no toner is supplied was elongated to three minutes, the static torque of the developing apparatus 504 was increased to 2.2 kgf·cm, and lost tooth was generated at the driving portion from the apparatus body 10A to the developing apparatus 504. The assembleability was not good.

In Comparative Example 5, the toner storage chamber 21 was arranged below the supply roller 24 in the direction of the gravitational force. Therefore, it took three minutes or so from when the stirring conveying member 22 feeds the toner from the toner storage chamber 21 to the developing chamber 23 from a state immediately after having pulling out the seal member 29, until a sufficient amount of toner in the developing chamber 23 was secured. Consequently, in Comparative Example 5, the static torque was increased before the sufficient amount of toner in the developing chamber 23 was secured, so that not only the power consumption was increased, but also the lost tooth occurred at the driving portion.

Example 3, in the same manner as Example 2, employed a configuration in which 50 mg of toner was carried on the developing roller 25, which was a configuration in which the low power consumption at a low torque was achieved at the time of activation and the assembleability was good. The supply roller 24 and the developing roller 25 rotated respectively so that the surfaces come into contact with each other at the nip portion N and rotate in the same direction (the direction moving from up to down in FIGS. 7A and 7B). At this time, in the same manner as Comparative Examples, the material of the supply roller 24 was the polyurethane foam having a surface cell diameter of 300 μm and an outer diameter of 12.0 mm. The amount of intrusion of the supply roller 24 into the developing roller 25 was 1.5 mm, and the supply roller 24 rotated in the same direction as the developing roller 25 as indicated by an arrow in FIG. 7B.

In Example 3, the supply roller 24 was driven at a number of rotations of 200 rpm, and the developing roller 25 was driven at a number of rotations of 100 rpm. Here, the supply roller 24 was set to rotate 1.5 turns while the developing roller 25 rotates 360°. However, the invention is not limited thereto.

The characteristics of the invention is that powder applied to the developing roller 25 is spread over the entire surface of the supply roller 24 by setting the supply roller 24 to rotate at least 360° while the developing roller 25 rotates 360° at the time of initial driving of the developing apparatus 504. In other words, with the configuration of Example 3, the supply roller 24 rotates just 360° while the developing roller 25 rotates 360° if the number of rotations of the supply roller 24 is 134 rpm or larger. In this configuration, the powder is adhered on the surface of the supply roller 24 and functions as lubricant between the supply roller 24 and the developing roller 25, so that generation of chips of the supply roller 24 or breakage of the developing apparatus 504 and the image forming apparatus may be prevented.

Subsequently, in Example 3, when the rollers were rotated without the supply of toner, the static torque after 10 seconds became 0.75 kgf·cm. When the rollers were rotated without the supply of toner after two minutes, the static torque became only to 1.1 kgf·cm and, furthermore, even when the rollers were rotated without the supply of toner after three minutes, the static torque was increased only to 1.4 kgf·cm.

In the configuration as Example 3, when the toner was fed from the toner storage chamber 21 to the developing chamber 23 by the stirring conveying member 22, the toner adhered on the surface of the supply roller 24 was fed to the upper portion of the supply roller 24. In this case, in Example 3, by the supply roller 24 and the developing roller 25 coming in contact with each other at the nip portion N so that the surfaces thereof move in the same direction (in the direction downward from above in Example 3), the toner could be accumulated in a toner storage section 19. In Comparative Example 5, since the supply roller 24 rotated in the direction in which the toner adhered on the surface of the supply roller 24 was returned back to the toner storage chamber 21, the toner could not be accumulated in the toner storage section 19.

In the configuration in which the toner was fed from the toner storage chamber 21 to the developing chamber 23, it took three minutes until the interior of the developing chamber 23 was filled with the toner. However, in Example 3, the toner required by the developing roller 25 and the supply roller 24 could be secured sufficiently by the effect as described above within one minute. Therefore, Example 3 was further advantageous in terms of the torque increase.

With the effects as described above, static torques in the range from 0.65 kgf·cm to 0.85 kgf·cm were achieved after one minute from a moment when the seal member 29 was pulled out. In this manner, in a configuration in which the toner storage chamber 21 is arranged below the supply roller 24 in the direction of gravitational force and the stirring conveying member 22 feeds the toner from the toner storage chamber 21 to the developing chamber 23 from a state immediately after the seal member 29 was pulled out, the torque increase from immediately after the pulling-out of the seal member 29 was prevented. Also, the power consumption at that time was reduced, and occurrence of breakage of the supply roller 24 or breakage of the drive system was prevented. Furthermore, since the amount of application of the powder to the developing roller 25 may be reduced in the same manner as Example 2, the assembleability was also improved.

According to the configuration of Example 2 or 3, in the configuration in which the powder W is retained on the developing roller 25 from a pair of the developing roller 25 and the supply roller 24, further reduction of the initial drive torque is achieved. (1) In other words, since the developing roller 25 and the supply roller 24 are set so that the both surfaces rotate in the same direction at the contact portion R therebetween, reduction of the initial drive torque is realized. (2) In addition, since the supply roller 24 is set to rotate at least 360° while the developing roller 25 rotates 360°, the powder W on the surface of the developing roller 25 is secured at the contact portion R between the developing roller 25 and the supply roller 24, and hence reduction of the initial drive torque as described above is achieved. It is because when the supply roller 24 rotates only less than 360° while the developing roller 25 rotates 360°, for example, the supply roller 24 cannot obtain the powder W from the developing roller after all the powder W on the surface of the developing roller 25 is distributed to the contact portion R.

According to the configuration of Example 2 or 3, (3) in addition, since the initial drive torque is reduced, the damage of the supply roller 24 is restrained, and the power consumption is reduced. (4) In addition, since the seal member 29 seals between the toner storage chamber 21 and the developing chamber 23, the phenomenon that the toner T leaks is restrained, and the assembleability is improved. Furthermore, (5) since the powder W is retained on the surface of the developing roller 25 and the powder W is not retained on the surface of the supply roller 24, improvement of the assembleability is realized.

In Examples 2 and 3, a configuration in which the developing apparatus 504 which is not provided with the photosensitive drum 1 is exemplified. However, the invention is not limited to this configuration. In other words, a process cartridge integrated with the photosensitive drum 1 or the like may be employed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-100958 filed Apr. 26, 2012 and No. 2012-101862 filed Apr. 26, 2012, which are hereby incorporated by reference herein in their entirety.

What is claimed is:

1. An image forming apparatus comprising:
an image carrying member on which an electrostatic latent image is carried;
a developing apparatus including: a developer carrying member configured to form a first nip portion with respect to the image carrying member and develop the electrostatic latent image at the first nip portion;
a supply member configured to form a second nip portion with respect to the developer carrying member and supply a developer to the developer carrying member at the second nip portion;
a storage section arranged below the supply member and configured to store the developer; and
a conveying member configured to convey the developer in the storage section on the supply member,
wherein
the surface of the developer carrying member moves in the same direction as the surface of the image carrying member and at a speed higher than the surface of the image carrier member at the first nip portion, and
the surface of the supply member moves in the same direction as the surface of the developer carrying member and at a speed higher than the surface of the developer carrying member at the second nip portion.

2. An image forming apparatus according to claim 1, wherein the peripheral speed difference between the supply member and the developer carrying member at the second nip portion is larger than the peripheral speed difference between the image carrying member and the developer carrying member at the first nip portion.

3. The image forming apparatus according to claim 1, wherein the peripheral speed difference between the image carrying member and the developer carrying member at the first nip portion is 10 mm/sec or higher.

4. The image forming apparatus according to claim 1, further comprising:
a bias application unit configured to apply bias voltages to the supply member and the developer carrying member so that the value obtained by subtracting the bias value applied to the developer carrying member from the bias value to be applied to the supply member becomes the same polarity as the normal charging polarity of the developer.

5. The image forming apparatus according to claim 1, wherein
the developing apparatus is provided with a removable seal member configured to prevent the developer from flowing from the storage section into the developer carrying member,
powder is retained on the surface of the developer carrying member in a state in which the developing apparatus is not in use, and
the supply member rotates 360° or more while the developer carrying member rotates 360° during the initial stage of driving of the developing apparatus.

6. The image forming apparatus according to claim 5, wherein the powder has a charging capacity of zero or is charged in the same polarity as the developer and the absolute value of the charging capacity is 1.5 times the absolute value of the charging capacity of the developer or smaller.

7. The image forming apparatus according to claim 5, wherein the powder is a developer or metal oxide.

8. The image forming apparatus according to claim 5, wherein the powder is a colorless powder or a developer having the highest brightness among the developers used for the image forming apparatus.

9. The image forming apparatus according to claim 1, wherein the supply member has a form layer on the surface thereof.

10. The image forming apparatus according to claim 1, wherein the developer is one-component developer.

11. A developing apparatus comprising:
a developer carrying member configured to carry developer and develop an electrostatic latent image;
a supply member configured to form a nip portion with respect to the developer carrying member and supply a developer to the developer carrying member at the nip portion;
a storage chamber configured to store the developer; and
a removable seal member configured to prevent the developer from flowing from the storage section to the developer carrying member,
wherein powder is retained on the surface of the developer carrying member in a state in which the developing apparatus is not in use, and the developer carrying member and the supply member rotate so as to move in the same direction at the nip portion and the supply member rotates 360° or more until the developer carrying member rotates 360° at the time of initial driving of the developing apparatus.

12. The developing apparatus according to claim 11, wherein the storage chamber arranged below the supply member, and a conveying member configured to convey the developer in the storage chamber on the supply member.

13. The developing apparatus according to claim 11, wherein the powder has a charging capacity of zero or is charged in the same polarity as the developer and the absolute value of the charging capacity is 1.5 times the absolute value of the charging capacity of the developer or smaller.

14. The developing apparatus according to claim 11, wherein the powder is a developer or metal oxide.

15. The developing apparatus according to claim 11, wherein the powder is a colorless powder or a developer having the highest brightness among the developers used for the image forming apparatus which uses the developing apparatus.

16. The developing apparatus according to claim 11, wherein the supply member has a form layer on the surface thereof.

17. The developing apparatus according to claim 11, wherein the developer is one-component developer.

18. A process cartridge demountably mountable on an image forming apparatus body comprising:
the developing apparatus according to claim 11, and
an image carrying member on which a static latent image is formed.

19. An image forming apparatus comprising:
an image forming portion configured to form an image; and
the developing apparatus according to claim 11.
